(19) United States
(12) Patent Application Publication
(10) Pub. No.: US 2009/0309809 A1
(43) Pub. Date: Dec. 17, 2009

(54) Automatic Method of Display Configuration-Reconfiguration for a Set of Viewing Devices

(75) Inventors: Yannick Thiry, Biganos (FR); Yannick Le Roux, Le Haillan (FR); Pierre Mariani, Le Bouscat (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/482,873

(22) Filed: Jun. 11, 2009

(30) Foreign Application Priority Data
Jun. 13, 2008 (FR) 08 03319

(51) Int. Cl. G09G 5/00

(52) U.S. Cl. 345/1.3

(57) ABSTRACT

The field of the invention is that of systems comprising command or control facilities possessing a considerable set of viewing devices having to display a large number of parameters according to precise configurations such as, for example, the instrument panels of modern aircraft comprising several “displays”. The subject of the invention is a method of configuring or reconfiguring a plurality of displays on a set of viewing devices, configuration or reconfiguration being induced by an event, certain viewing devices being able to display several different formats simultaneously. Each elementary configuration is obtained essentially by means of a reconfiguration logic language and of an interpretation algorithm, the said logic language comprising essentially a reconfiguration domain, properties, transition rules and preferences and the said interpretation algorithm making it possible to transform each transition rule into a list of elementary reconfigurations.

### PRIORITY CLAIM

This application claims priority to French Patent Application No. 08 03319, entitled Automatic Method of Display Configuration-Reconfiguration for a Set of Viewing Devices, filed on Jun. 13, 2008.

### BACKGROUND OF THE INVENTION

1. Field of the Invention

The field of the invention is that of systems comprising command or control facilities possessing a considerable set of viewing devices having to display a large number of parameters according to precise configurations so that, for example, certain information vital for the operation or the safety of the system is always displayed in the most ergonomic possible manner.

2. Description of the Prior Art

The favoured application field is aeronautics. Specifically, the instrument panels of modern aircraft possess at one and the same time a large number of viewing screens that will be referred to subsequently in the text as either “VDUs” or else “displays” and a large number of different displays that will also be referred to as “formats” subsequently in the text.

Thus, the instrument panel of an Airbus A380 possesses eight main screens and about ten possible configurations per screen. FIG. 1 shows an example of displays in an Airbus A380 cockpit. The eight VDUs are referred to as L1, L2, L3, C1, C2, R1, R2 and R3 respectively. In general, a format is not specific to a particular VDU: it can be displayed successively or simultaneously on several different VDUs. The so-called PFD format, the acronym standing for “Primary Flight Display”, is a format providing the pilot with all the primary flight data such as the altitude or heading. In the example of FIG. 1, the PFD format is displayed at one and the same time by the VDUs L1 and R1. The control boards CPL and CPR depicted in FIG. 1 allow the pilot to intervene so as to select, enter and modify the information displayed.

This invention can however be applied to other technical or industrial fields such as command or control rooms possessing considerable sets of viewing devices and requiring considerable reliability and safety levels.

In the case of an aircraft instrument panel, it must be easily possible to configure or reconfigure the formats displayed on the VDUs so as:
To ensure the availability of the critical functions, vital for piloting or navigation;
To adapt the configuration of the cockpit to the mission or to the flight phase desired.

The term configuration is understood to mean a state of the instrument panel defining the formats displayed on each VDU and the term reconfiguration is understood to mean a change of state of the instrument panel related to an event.

It is of course possible to ensure the management of the configurations-reconfigurations of the formats through a double-entry configuration table. The first entry gives the events liable to give rise to a reconfiguration and the second entry gives the configuration adopted as a function of the event occurring. This solution is applicable as long as the number of elements of the table remains reasonable. This solution may become very unwieldy to create and sustain when the possible number of viewings and configurations increases. Now, most reconfigurations depend on logic rules which exhibit the advantage of making it possible to synthesize in a consistent manner a large number of possible cases that it is irksome to enumerate exhaustively in a configuration table. Thus, PCT patent application referenced WO 2007/042477 entitled: “Display configuration-reconfiguration method for a set of display devices” proposes to replace the realization of a configuration table by a method which, on the basis of these logic rules, generates the desired reconfiguration in an automatic manner. The principle of this algorithm is set forth in FIG. 2. The method relates to the configuration or the reconfiguration of a plurality of displays referred to as formats on a set of viewing devices referred to as VDUs, reconfiguration of an initial configuration being induced by a cause referred to as an event so as to culminate in a final configuration, each configuration is obtained essentially by means of a reconfiguration logic language and of an interpretation algorithm, the said logic language comprising:
A reconfiguration domain: set of elements comprising mainly:
   “places” mainly modelling the VDUs;
   “tokens” mainly modelling the formats;
   the “events”;
   the logic functions which unite the “places”, the “tokens” and the “events”;
Properties, set of rules defining the acceptable configurations;
Transition rules, set of rules defining the acceptable reconfigurations;
Preferences defining an order of calculation and priority formats on the VDUs;

This language makes it possible to describe the domain, the properties, the transition rules and the preferences in a synthetic manner. It possesses a formal syntax akin to a mathematical language.

The interpretation algorithm makes it possible to transform each transition rule into a list of elementary reconfigurations.

By way of example, the main rules are:
Rules of uniqueness for the formats per half-cockpit (each half-cockpit displays the same information);
Rules for requesting formats on a VDU;
Rules for turning on the VDUs;
Rules for turning off the VDUs;
Rules of priority of display of the formats;
Rules of obligation of display for the highest priority formats.

However, the method described exhibits a drawback. With the enlargement of the surface areas of VDUs, it is today possible to display several formats within one and the same VDU as indicated in FIG. 3 which represents three different “sub-formats” on the same VDU L1 (a format of PFD type on the right of the figure, a text screen at the top left and a display of “engine control” type at the bottom left). Hereinafter, the term “window” will refer to the zone of display of a sub-format in a VDU when the latter can display several sub-formats simultaneously. The “sub-formats” are also referred to as “pages”. A page can be composed of one or more sub-pages referred to as “layers”, but this composition is static. There is no reconfiguring of “layers” inside one and the same page.

This case may not be handled simply with the algorithm for reconfigurations without adaptations. Specifically, the basic principle of this algorithm is that a place (a VDU for example) may, at a given instant, contain one and only one “token” (a format for example). Moreover, this solution does not allow direct management of the finest level expected, that is to say the level of the particular arrangement of the “windows” in a “place”. Indeed, in practice, a VDU displays one or more windows, each of which can display a sub-format.

This point is not necessarily simple to handle. To manage the finest level of the reconfigurations, it is necessary either to resort to spreadsheet arrays of “Excel” type exhaustively detailing all the possible “window” layouts and all the possible format associations or else to specify state machines which also make it compulsory to list all the states. In all cases, with the increase in the complexity of instrument panels also referred to as the “Glass Cockpit”, these two ways of managing this new reconfiguration level are not optimal in terms of workload, maintenance and upgrade. It is in fact fairly well understood that if this “Windows” second reconfiguration level has a complexity, if only some hundred possible cases, the least upgrade having an impact on several cases, becomes extremely complex to manage. Moreover, with these two solutions, it is also necessary to manually develop the interface between the code generated automatically for the VDU/format reconfigurations and the Excel Formats/Windows/Layers files.

### SUMMARY OF THE INVENTION

The basic principle of the method according to the invention is to modify the data model used by the algorithm which is only aware of the concepts of “place” and “token”so as to be able to manage a reconfiguration of N “tokens” in a “place” by performing N+1 reconfigurations of a “token” in a “place”. To define the value of the number “N”, it is necessary to introduce the concept of “layout” corresponding to the various ways of laying out the “windows” on a VDU. Each “layout” defines strictly N “windows” defined by their position, their size and their properties and will thus make it possible, in the guise of first reconfiguration level (VDU/Layout), to determine how many reconfigurations of second level (Window/Format) have to be performed.

### BRIEF DESCRIPTION OF THE DRAWINGS

The invention will be better understood and other advantages will become apparent on reading the nonlimiting description which follows and by virtue of the appended figures among which:

FIG. 1 represents an instrument panel comprising 8 VDUs;

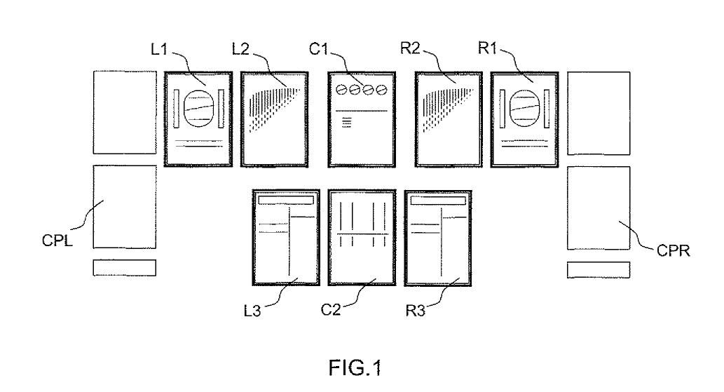

FIG. 2 represents the chart of the configuration method according to the invention;

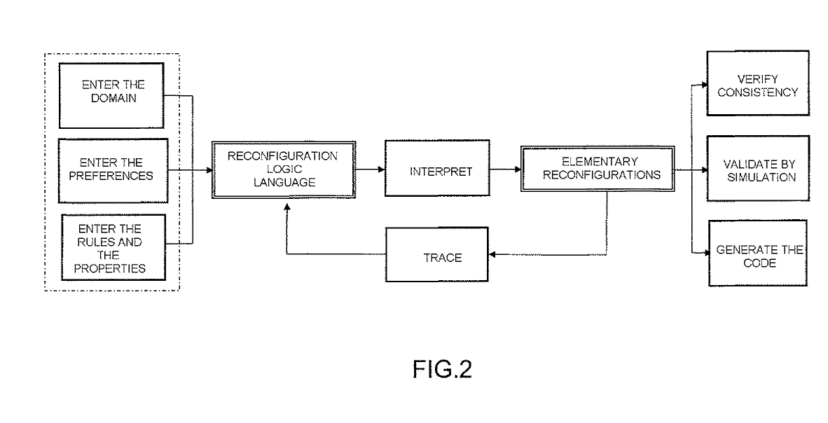

FIG. 3 represents a partial view of a VDU set making it possible to display several formats;

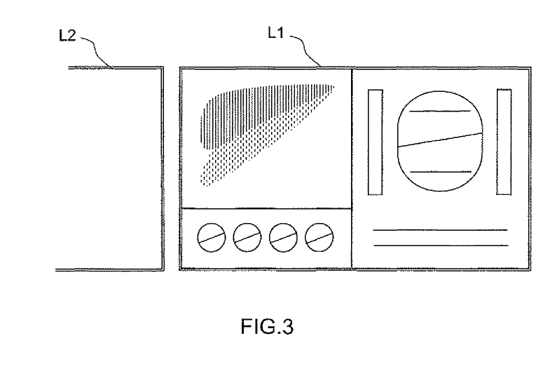

FIG. 4 represents the new steps of the method according to the invention.

### MORE DETAILED DESCRIPTION

More precisely, the invention relates to a method of configuring and reconfiguring a plurality of displays referred to as “formats” on a set of viewing devices referred to as “VDUs”, reconfiguration of an initial configuration being induced by a cause referred to as an “event” so as to culminate in a final configuration, each configuration being obtained essentially by means of a reconfiguration logic language and of an interpretation algorithm, the said logic language comprising:
A reconfiguration domain: set of elements comprising mainly
   “places” mainly modelling the VDUs;
   “tokens” mainly modelling the formats;
   the events;
   the logic functions which unite the “places”, the “tokens” and the events;
Properties: set of rules defining the acceptable configurations;
Transition rules: set of rules defining the acceptable reconfigurations;
Preferences defining an order of calculation and priority formats on the VDUs; and the said interpretation algorithm making it possible to transform each transition rule into a list of final reconfigurations,
characterized in that, when several different formats can be laid out on one and the same viewing device, the reconfiguration domain comprises:
   a set of elements referred to as “layouts”, each layout modelling a particular arrangement of one or more “tokens” on one and the same “place”,
   the said arrangement comprising one or more “windows”, each window being defined by its position, its size and its properties, in such a way that if N is the maximum number of “windows” in a given “place”, the configuration or the reconfiguration of a “token” is performed in two stages:
   In a first stage, the windows are processed by the algorithm as “places” making it possible to determine the locations of the “tokens” on the “windows”;
   In a second stage, the algorithm determines the configuration or the reconfiguration of the “layouts” of the “windows” on each “place”.

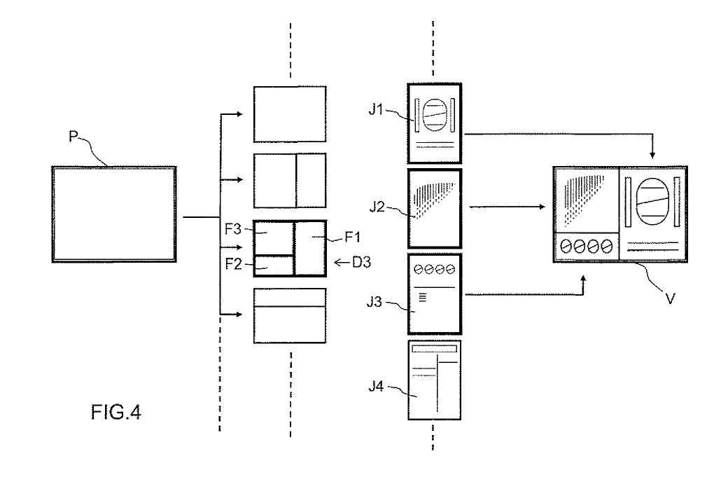

The new steps of the method according to the invention are illustrated in FIG. 4. The VDU or “place” P can comprise several possible “layouts” of “windows”. In FIG. 4, four layouts D of windows F are represented by way of example. In this example, the layout D3 comprises three “windows” denoted F1, F2 and F3, this layout D3 is represented in bold in FIG. 4. In a first stage, the windows F are processed by the algorithm as “places” making it possible to determine the locations of the “tokens” on the “windows” by means of the logic language and of the interpretation algorithm such as they have been previously defined. In FIG. 4, four different “tokens” J are represented, representative of the various types of display that one wishes to display. The interpretation algorithm will adopt three of them. The tokens J1, J2 and J3 adopted are represented in bold in FIG. 4.

In a second stage, the algorithm determines the configuration or the reconfiguration of the “layouts” of the “windows” on each “place”. Ultimately, the distribution of the formats on the VDU such as represented on the right part of FIG. 4 is obtained.

The simulation and the code generation rely on a basic process executed in a loop which, given an initial configuration and an event received, calculates the next configuration. It can take the form of a function which calculates the next configuration on the basis of a configuration and of an event.

The code generation involves a large number of possible solutions. For example, it is possible to write a generic reconfiguration function once and for all. The role of this function is to elect the elementary reconfiguration and to apply it. For this purpose, it uses the elementary reconfigurations generated either in the form of elementary data or arrays, or in the form of codes.

What is claimed is:

1. Method of configuring and reconfiguring a plurality of displays referred to as “formats” on a set of viewing devices referred to as “VDUs”, reconfiguration of an initial configuration being induced by a cause referred to as an “event” so as to culminate in a final configuration, each configuration being obtained essentially by means of a reconfiguration logic language and of an interpretation algorithm, the said logic language comprising:
A reconfiguration domain: set of elements comprising mainly
“places” mainly modelling the VDUs;
“tokens” mainly modelling the formats;
the events;
the logic functions which unite the “places”, the “tokens” and the events;
Properties: set of rules defining the acceptable configurations;
Transition rules: set of rules defining the acceptable reconfigurations;
Preferences defining an order of calculation and priority formats on the VDUs; and the said interpretation algorithm making it possible to transform each transition rule into a list of final reconfigurations,
wherein, when several different formats can be laid out on one and the same viewing device, the reconfiguration domain comprises:
a set of elements referred to as “layouts”, each layout modelling a particular arrangement of one or more “tokens” on one and the same “place”,
the said arrangement comprising one or more “windows”, each window being defined by its position, its size and its properties, in such a way that if N is the maximum number of “windows” in a given “place”, the configuration or the reconfiguration of a “token” is performed in two stages:
In a first stage, the windows are processed by the algorithm as “places” making it possible to determine the locations of the “tokens” on the “windows”;
In a second stage, the algorithm determines the configuration or the reconfiguration of the “layouts” of the “windows” on each “place”.
